(19) United States
(12) Patent Application Publication
(10) Pub. No.: US 2013/0311555 A1
(43) Pub. Date: Nov. 21, 2013

(54) METHOD FOR DISTRIBUTING LONG-TAIL CONTENT

(71) Applicants: Nikolaos LAOUTARIS, Madrid (ES); Vijay ERRAMILLI, Madrid (ES)

(72) Inventors: Nikolaos LAOUTARIS, Madrid (ES); Vijay ERRAMILLI, Madrid (ES)

(73) Assignee: TELEFONICA, S.A., Madrid (ES)

(21) Appl. No.: 13/475,131

(22) Filed: May 18, 2012

(51) Int. Cl. G06F 15/16

(52) U.S. Cl. 709/204

(57) ABSTRACT

A method for distributing long-tail content, including the steps of: a) loading, a first user, into a local PoP to which said first user is remotely connected an amount of long-tail content to be distributed and shared; and b) geo replicating, at selected times, the amount of long-tail content to a at least one remote PoP, to which at least a second user is remotely connected, by pushing said amount of content to be distributed and shared to the at least one remote PoP. The method including selecting, before performing steps a) and b), the at least second user, based on the probability that the amount of long-tail content generated by the first user will be requested by the at least second user, the probability being estimated by historical preference information generated between the first user and the at least second user.

### FIELD OF THE ART

The present invention generally relates to a method for content distribution, and more particularly to a method for distributing long-tail content to users distributed across PoPs.

By means of long-tail content it will be understood that information (video, audio) only of interest to a reduced number of potential users.

### PRIOR STATE OF THE ART

Online content distribution technologies have witnessed much advancement over the last decade, from large CDNs to P2P technologies, but most of these technologies are inadequate while handling unpopular or long-tailed content. CDNs find it economically in feasible to deal with such content—the distribution costs for content that will be consumed by very few people globally is higher than the utility derived from delivering such content [2]. Unmanaged P2P systems suffer from peer/seeder shortage and meeting bandwidth and/or QoE constraints for such content. The problem of delivering such content is further exacerbated by two recent trends: the increasing popularity of user-generated content (UGC) and online social networks (OSNs) create and reinforce such popularity distributions. Second, the recent trend of geo-replicating content across multiple PoPs spread around the world, done for improving quality of experience (QoE) for users and for redundancy reasons, can lead to unnecessary bandwidth costs. For instance, Facebook hosts more images than all other popular photo hosting websites such as in terms of views Flickr, and they now host and serve a large proportion of videos as well.

Content created and shared on social networks is predominantly long-tailed with a limited interest group, especially if one considers notions like Dunbar's number [3].The increasing adoption of smartphones, with advanced capabilities, will further drive this trend. In order to deliver content and handle a diverse userbase [4], most large distributed systems are relying on geo-diversification, with storage in the network. One can push or prestage content to geo-diversified PoPs closest to the user, hence limiting the parts of the network affected by a request and improving QoE for the user in terms of reduced latency. However, it has been shown that transferring content between such PoPs can be expensive due to bandwidth costs [6]. For long-tailed content, the problem is more acute—one can push content to PoPs, only to have it not consumed, wasting bandwidth. Inversely one can resort to pull, and transfer content only upon request, but leading to increased latencies and potentially contributing to the peak load. Given the factors above, along with the inability of current technologies to handle such content [2] while keeping bandwidth costs low, it would appear that distributing long-tailed content is and will be a difficult endeavour.

There are some inventions related to online content, some of the most important are: the US 2009/0168752 which provides a method for distributing content to one or more destination nodes, and the WO 2009/052963 which is related to a method for caching content data packages from nodes. These two solutions are not related to long-tailed content as the present invention and do not exploit social relationships from OSN and time-zone differences to efficiently and selectively distribute long-tail content.

### SUMMARY OF THE INVENTION

It is necessary to offer an alternative to the state of the art which covers the gaps found therein, particularly those related to the lack of proposals which allow the distribution of long-tail content across PoPs reducing bandwidth usage at peak times and costs and resolving latency for end users, improving QoE.

To that end, the present invention provides a method for distributing long-tail content, said method comprising the steps of:

a) loading, a first user, into a local PoP to which said first user is remotely connected an amount of long-tail content to be distributed and shared; and

b) geo replicating, at selected times, said amount of long-tail content to a at least one remote PoP, to which at least a second user is remotely connected, by pushing said amount of content to be distributed and shared to said at least one remote PoP,

On contrary to the known proposals, said method comprises selecting, before performing said steps a) and b), said at least second user, based on the probability that said amount of long-tail content generated by said first user will be requested by said at least second user, said probability being estimated by means of a historical preference information generated between said first user and said at least second user.

The method also comprises calculating said selected times for amount of long-tail content geo replication of step b) based on an expected time of consumption by said at least second user and estimating said selected times based on a network traffic condition in order to use bandwidth at outside peak consumption times.

On a preferred embodiment of the present invention, said historical preference information is based on social information from past history interactions taken from a social network established between said first user and said at least second user.

Other embodiment of the present invention comprises scheduling said amount of long-tail content to be distributed and shared by exploiting time-zone differences.

Other embodiments of the method of the first aspect of the invention are described according to appended claims 2 to 14, and in a subsequent section related to the detailed description of several embodiments.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 shows an example of the generic distributed architecture used for this invention, where there are multiples Servers or PoPs geo-distributed, handling content for geographically close users.

FIG. 2 represents the update patterns given by the data and synthetic reads generated for the day dataset for all the four centers: (a) London (b) Tokyo (c) LA (d) Boston considered, according to an embodiment of the present invention.

FIG. 3 shows the performance figures for Youtube® videos, improvements for download times for buffering stage.

### DETAILED DESCRIPTION OF SEVERAL EMBODIMENTS

The present invention presents a system called TailGate that can distribute long-tailed content while lowering bandwidth costs and improving QoE. The key to distribution is to know: (i) where the content will likely be consumed, and (ii) when. Knowing the answers, content can be pushed where-ever it is needed, at a time before it is needed, and such that bandwidth costs are minimized under peak based pricing schemes like 95th percentile pricing. Although in this invention focuses on this pricing scheme, it needs to be stressed that lowering the peak is beneficial also under flat rate schemes or even with owned links since network dimensioning in both cases depends on the peak. Recent proposals like NetSticher [6] have proposed systems to distribute content between geodiversified centers, while minimizing bandwidth costs. TailGate augments such solutions by relying on a hith-1 erto untapped resource—information readily available from OSNs. More specifically, TailGate relies on the rich and ubiquitous information—friendship links, regularity of activity and information dissemination via the social network. TailGate is built around the following notions that dictate consumption patterns of users. First, users follow strong diurnal trends while accessing data [7].

Second, in a geo-diverse system, there exist time-zone differences between sites. Third, the social graph provides information on who will likely consume the content. At the center of TailGate is a scheduling mechanism that uses these notions. TailGate schedules content by exploiting time-zone differences that exist, and trying to spread and flatten out the traffic caused by moving content. The scheduling scheme enforces an informed push scheme, reduces peaks and hence the costs. In addition, the content is pushed to the relevant sites before it is likely accessed—reducing the latency for the end-users. TailGate is designed to be simple and adaptable to different deployment scenarios.

Results at a glance: In order to first understand which user's characteristics can be used by Tailgate and in order to know if these characteristics are useful, the invention turns to a large dataset collected from an OSN (Twitter®), consisting of over 8M users and over 100M content links shared. This data will help to understand where requests can come from as well as give an idea of when. Tailgate takes advantage of this information and compares Tailgate's performance in terms of reduction in bandwidth costs (as given by a reduction in the 95th percentile) and improving QoE for the user under different scenarios and using real data. When compared against a naive push, it can be seen a reduction of 80% in some scenarios and a reduction of around 30% over a pull based solution that is employed by most CDNs. For only long-tailed content, the improvement is even more. The quality of information available is varied to Tailgate and found even when TailGate has less precise information, TailGate still performs better than push and is similar to pull in terms of bandwidth costs, while lowering latency (improving QoE) for up to 10 times of the requests over pull. It is showed that even in an extreme setting where TailGate has lower access to information in a live setting; TailGate can reduce latency for the end-user to access long-tailed content by a factor of 2.

For the sake of exposition, a generic distributed architecture that will provide the template for the design and analysis of TailGate is discribed. In following sections it will be showed how this architecture can be used for different scenarios—OSN providers and CDNs. After describing the architecture, a simple motivating example is provided. At the end of the section a list with the requirements that a system like TailGate needs to fulfill is showed.

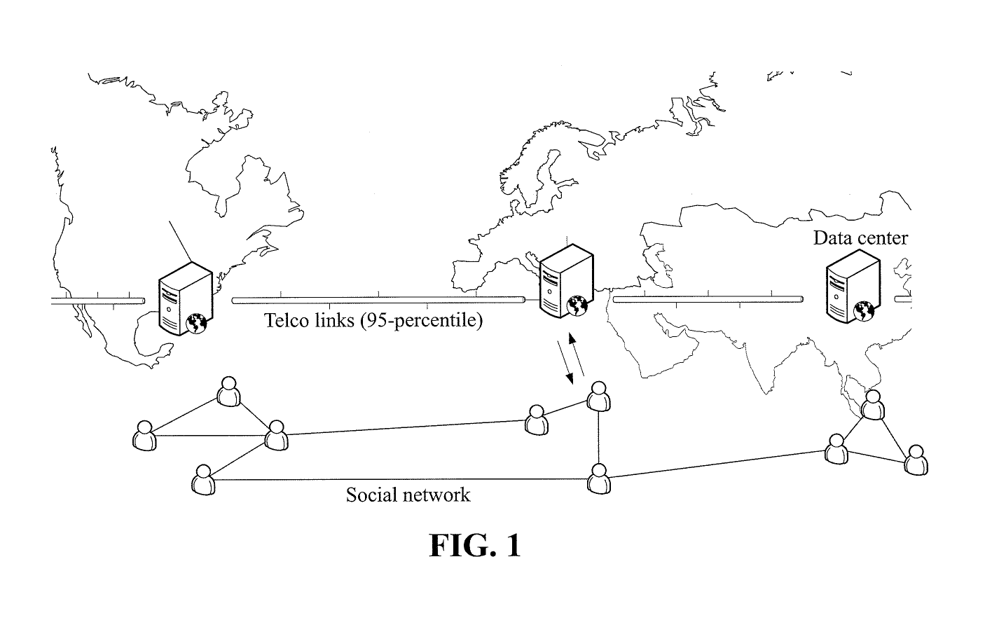

The invention architecture is considered as an online service having users distributed across the world. In order to cater to these users, the service is operated on a geo-diverse system comprising multiple points-of-presence (PoPs) distributed globally. These PoPs are connected to each other by links. These links can be owned by the entity owning the PoPs (for instance, Google or a Telco-operated CDN) or the bandwidth on these links can be leased from network providers. Users are assigned and served out of their nearest (geographically) PoP, for all their requests. Placing data close to the users is a maxim followed by most CDNs, replicated services, as well as research proposals like Volley [1]. Therefore all content uploaded by users is first uploaded to the nearest respective PoP. When content is requested by users, the nearest PoP is contacted and if the content is available there, the request is served. The content can be present at the same PoP if content was first uploaded there or was brought there by some other request. If the content is not available, then a pull request is made and the content is brought to the PoP and served. This is the de facto mechanism (also known as a cold-miss) used by most CDNs. The present invention uses this ‘serve-if-available’ else ‘pull-when-not available’ mechanism as the baseline and shall show that this scheme can lead to high bandwidth costs. An example of this architecture is shown in FIG. 1 where there are multiple interconnected PoPs around the world each serving a local user group.

An embodiment where TailGate is showed to be necessary is the next example. Considering a user Bob living in Boston and assigned to the Boston PoP in FIG. 1. Bob likes to generate and share content (videos, photos) with his friends and family. Most of Bob's social contacts are geographically close to him, but he has a few friends on the West Coast US, Europe and Asia. These geographically distributed set of friends are assigned to the nearest PoP respectively. Bob logs in to the application at 6 PM local time (peak time) and uploads a family video shot in HD that he wants to share. Like Bob, many users perform similar operations. A naive way to ensure this content to be as close as possible to all users before any accesses happen would be to push the updates/content to other PoPs immediately, at 6 PM. Aggregated over all users, this process of pushing immediately can lead to a traffic spike in the upload link. Worse still, this content may not be consumed at all thus having contributed to the spike unnecessarily. Alternatively, instead of pushing data immediately, we can wait till the first friend of Bob in each PoP access the content. For instance Alice, a friend of Bob's in London logs in at 12 PM local time and requests the content, and the system triggers a pull request, pulling it from Boston. However, user activity follow strong diurnal trends with peaks (12 PM London local), hence multiple requests by different users will lead to multiple pulls, leading to yet another traffic spike. The problem with caching long-tailed content is well documented [2], and this problem is further exacerbated when Alice is the only friend of Bob's in London interested in that content and there are many such Alices. Hence all these “Alices”will experience a low QoE (as they have to wait for the content to be downloaded) and the provider experiences higher bandwidth costs—a loss for all.

Instead of pushing content as soon as Bob uploads, wait till 2 AM Boston local time, which is off-peak for the uplink, to push the content to London where it will be 7 AM local time, again off-peak for downlink in London, and 7 AM is still earlier that 12 PM when Alice is likely to log in. Therefore Alice can access Bob's content quickly, hence experience relatively high QoE. The provider has transferred the content during off-peak hours, decreasing costs—a win win scenario for all. TailGate is built upon this intuition where such time differences between content being uploaded and content being accessed is exploited. In a geo-diverse system, such time differences exist anyway. However, in order to exploit these time differences, Tail-Gate needs information about the social graph (Alice is a friend of Bob), where these contacts reside (Alice lives in London) and the likely access patterns of Alice (she will likely access it at 12 PM).

TailGate Needs to Address and Balance the Following Requirements:

Reduce bandwidth costs: Despite the dropping price of leased WAN bandwidth and networking equipment, the growth rate of UGC combined with the incorporation of media rich long tail content (e.g. images and HD videos) makes WAN traffic costs a big concern. For instance, the traffic volume produced by photos on Facebook can be in thousands of GB from just one region, e.g. photos from NYC. This problem was handled in [6].

Decrease latency: The latency in the architecture described is due to two factors: one is the latency component in the access link between the user to the nearest PoP. The other component lies in getting that content from the source PoP, if the content is not available in the nearest PoP. Since the former is beyond the reach the invention focuses on getting the content to the closest PoPs.

Online and reactive: The scale of UGC systems can lead to thousands of transactions per second as well as a large volume of content being uploaded per second. In order to handle such volume any solution has to be online, simple and react quickly.

What TailGate does not do is optimizing bandwidth costs and does not consider storage constraints. It would be interesting to consider storage as well but it is believed the relatively lower costs of storage puts the emphasis on reducing bandwidth costs.

Optimization Metric: Bandwidth Costs:

The incoming and outgoing traffic volumes of each site Sₖ depends on the upload strategy and updates. In general, a peak-based pricing scheme is used as a cost function (pₖ(·)). The most common is the 95th percentile (q(·)) of the traffic volume (typically a linear function whose slope depends on the location of the site, i.e., bandwidth prices vary from one city to another). Therefore the bandwidth costs incurred at site Sₖ is cₖ=pₖ(max(q(vₖ^{l}), q(vₖ^{l}))) and the total bandwidth cost is the sum of all the cₖ.

Constraint: Latency Via Penalty Metric

In order to capture the notion of latency, which is closely related to a “cold-miss” at a site, for a user un at site Sₖ is captured by the number d_{n,k}^{[t]′}; updates of un that are missing at site Sₖ

$${d}_{n , k}^{[ t ]} = \{ \begin{matrix}{\sum }_{v = 0}^{{t}^{′} = t} {w}_{n}^{[ t ]} - {t}_{n , k}^{[ t ]} & if S ( {u}_{n} ) \neq {S}_{k} \\ 0 & otherwise\end{matrix}$$

which is representative of the number of times the content has to be fetched from the server where it is originally hosted, increasing latency. To evaluate the perceived latency, the invention defines a penalty system: every time a user requests one of her friends' updates and it is not available, the total penalty is incremented by the number above.

In order to keep TailGate simple, the invention resorts to a greedy heuristic to schedule content. At a high level, it is considered load on different links to be divided into discrete time bins (for instance, 5 min bins). Then, the heuristic is simple—given an upload (triggered by a write) at a given time at a given site that needs to be distributed to different sites, find or estimate the bin in the future in which this content will likely be read, and then schedule this content in the least loaded bin amongst the set of bins: (current bin, bin in which read occurs). If more than one candidate bin is found, pick a bin at random to schedule. Simultaneous uploads are handled randomly; no special preference is given to one upload over another. The salient points are highlighted of this approach: (i) This is an online scheme in the sense that content is scheduled as it is uploaded. (ii) This scheme optimizes for upload bandwidth only; a greedy variant is tried where it is optimized for upload and downloads bandwidth, but did not see much improvement, so a simpler scheme was settled for. (iii) If we have perfect reads, TailGate produces no penalties by design. However, this won't be the case and the tradeoff in the next section is quantified. (iv) In the presence of background traffic, one can use available bandwidth estimation tools to measure and forecast.

Two solutions are described as examples of embodiments. Push/FIFO and a pull based approach that mimics various cache-based solutions (including CDNs) that can be used to distribute long-tailed content. For all the schemes considered, it is assumed that storage is cheap and once content (for instance a video) is delivered to a site, all future requests for that content originating from users of that site will be served locally. In other words, content is moved between sites only once. Flash-crowd effects etc. are therefore handled by the nearest PoP. The key difference between schemes is when the content is delivered. Immediate Push/FIFO: The content is distributed to different PoPs as soon as it is uploaded. Assuming there are no losses in the network, FIFO decreases latency for accesses as content will always be served from the nearest PoP. Pull: The content is distributed only when the first read request is made for that content. This scheme therefore depends on read patterns and we use the synthetic reads to figure out the first read for each upload. Note that in this scenario, the user who issues the first read will experience higher latency.

As TailGate uses social information, the obvious questions to ask are (i) what type of information is useful and available, (ii) how can such information be used? For answering these questions, the invention relies on data from Twitter®. The invention relies on a large dataset of 41.7M users with 1.478 edges obtained through a massive crawl of Twitter between June-September 2009 [5]. For these users, location information is then collected by conducting our own crawl, processed the data for junk, ambiguous information and translated everything to latitude/longitude using Google Maps® API. In the end, location for 8,092,624 users is extracted from about 11M users that have actually entered location information. This social graph is used, nodes and edges only between these nodes for the invention analysis. With regards to the location of the users in the dataset, it is found that US has the maximum number of users (55.7%), followed by UK (7.02%) and Canada (3.9%). In terms of cities, New York has the highest number of users (2.9%), followed by London (1.7%) and LA (1.47%). 4.0.1 Upload Activity For the users who have locations, their tweets are collected. Twitter allows collection of the last 3200 tweets per user, but in the invention dataset it is found that the mean number of tweets was 42 per user. Not all users had tweet activity; the number of active users (who tweeted at least once) was 6.3M users. For these 6.3M users, the invention ended up collecting approximately 499M tweets, till Nov. 2010. This dataset is valuable in characterizing activity patterns of users. From these tweets, it extracted those tweets that contain hyperlinks pertaining to pictures (plixi, Twitpic etc.) and videos (Youtube®, Dailymotion®, etc.) which were considered as UGC, which resulted in 101,079,568 links.

The analysis was focused on two time periods extracted from this long trace. The first one is called day and consists to the set of activities on 20 May 2010 the day that it is noted the maximum number of tweets in the invention dataset and the second one is called week consists of a week of activity extracted from 15 Mar. 2010 to 21 Mar. 2010 that is a generic week. The size of each piece of content that is shared is recorded, resolving URL shorteners as the case may be. The largest file happened to be of a cricket match on Youtube®, with a size 1.3G on 480 p (medium quality). The number of views for each link is collected, wherever available and the closest (KL distance) fit was the lognormal distribution (parameters: (10.29,3.50)) and it is found around 30% of the content to be viewed less than 500 times. The most popular was a music video by Lady Gaga on Youtube®, viewed more than 300M times.

Geo-distributed PoPs: To study the effects of geo-diversity on bandwidth costs, the invention uses location data and assigns users to PoPs distributed around the world. The distributed architecture described in previous sections is assumed and assumes there exist datacenters in these four locations: Boston, London, LA and Tokyo2. These locations are chosen in order to cover the globe. Users are assigned to locations using a simple method: compute the distance of a user to a location, and assign the user to the nearest location. For computing the distances a Haversine distance is used [8]. For the four locations, following distribution of users are gotten: (Boston: 3,476,676, London: 1,684,101, LA: 2,045,274, Tokyo: 886,573). The east-coast of US dominates in the invention datasets. The relatively low number of users in Asia is because most users in Asia prefer a local version of an OSN. However, the invention chooses Tokyo precisely for this point—users in Asia comprise social contacts of users from around the world, sharing and requesting content, adding to bandwidth costs. The invention finds that on average, a user has 19.72 followers in her own cluster and 8.91 followers in each of the other clusters. It is well known that contacts or “friends” in social networks are located close together with respect to geographical distance [10].

Read Activity: TailGate relies on information about accesses; reads. The ideal information will be who requests the content, and when. It could not be obtained direct read patterns from Twitter®/Facebook® as they are not available. So it is proceeding as follows. To get an idea on who requests, packet traces are collected via TCPDump from an outgoing link connecting a university in northern Italy (9 Mar. 2011) to 2Note that datacenter operators such as Equinix® already have data centers in several of these locations.

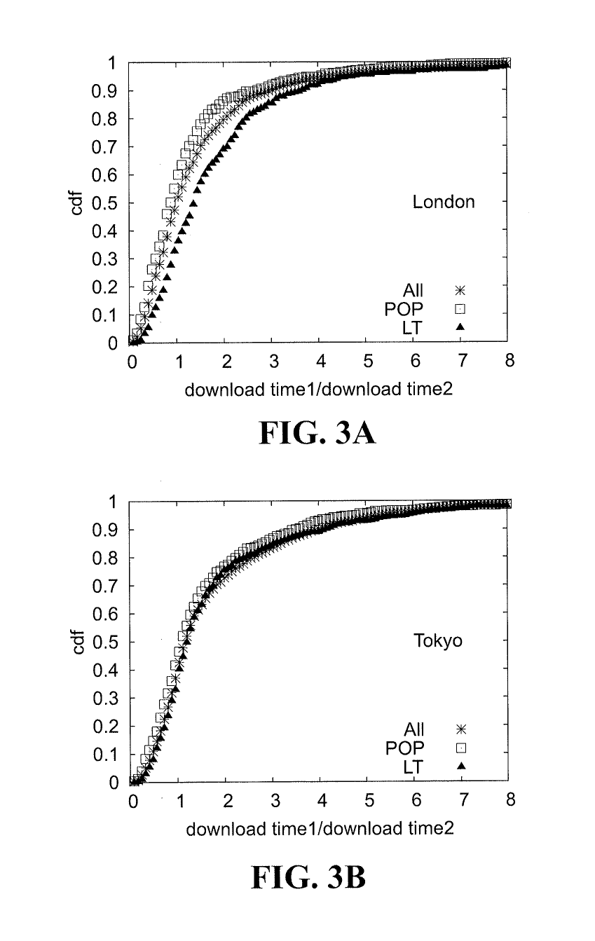

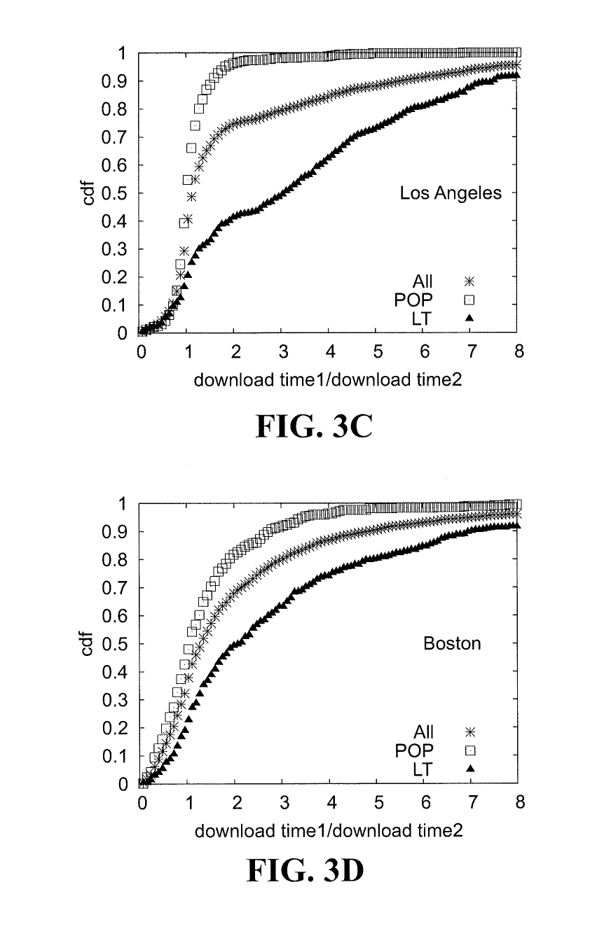

Another possible embodiment where the present invention is suitable is for using Long-tailed videos on Youtube®. In this section, it will be studied the limiting case where TailGate has little access to social information (NIIR), but can help with QoE in the case of long-tailed Youtube® videos. The entity controlling TailGate (eg. CDN) can rely on publicly available information (; Tweets) as it is done here and use TailGate to request or “pull” content to intelligently prefetch content before the real requests for the content—thereby decreasing latency for their customers. Towards this end, a simple prototype of Tailgate is develop based on the design deploy it on four PlanetLab nodes at the same four locations—Boston, London, LA and Tokyo. It is preceded as follows: The invention relies on the dataset described before where the four sets of users to different “PoPs” as given by Planetlab nodes are assigned. The set of links that correspond to Youtube® videos from the dataset are extracted, along with the times they were posted. It can be noted that this information is public—anyone can collect this information. Then the invention provides this set of writes as input to TailGate, assuming no social information (; graph structure not used) and assuming the expected reads in various locations follow a diurnal pattern. The invention gets a schedule as output of TailGate that effectively schedules transfers between the four locations. This schedule is taken and instead directly requests the Youtube® videos from various sites, at a time given by Tailgate, in effect “emulating” transfers. After that the videos at the time of the “read” are requested, that is, the invention “emulate” users from each location issuing read requests for each video by sampling from the diurnal trend. Therefore each video gets requested twice—first time for emulating the transfer using a schedule given by TailGate, and the second time, emulating a legitimate request by a user to quantify the benefit. It can be noted that the first request would also be emulating a PULL, as the invention emulates a cold-miss. Hence any improvements noticed would be an improvement over PULL. The invention uses get with the-no-cache option for all our operations, to avoid caching effects as much as possible, focusing on the Quality of experience (QoE) for the end-user. In order to measure that, the invention first looks at the proportion of a file that is downloaded during the initial buffering stage, after which the playout of the video is smooth. The playout is said to be smooth if the download rate for a file drops by 70% of what was the original rate. Other values were tested obtaining similar results. It was found that on average, the playback is smooth after 15% of a file is downloaded. Therefore it was noted the delay in terms of time it takes for the first 15% of a file to be downloaded. As the invention downloads each video twice, once at a time given by TailGate and the second as representing the actual read request, it measures both and plot the cdfs of ratios (dload time1/dload time2) in FIG. 3. It plots it for three different cases: “all” is the entire dataset, “pop” stands for only those videos that are popular (& 500K views) and “LT” which stands for long-tailed videos ('1100 views). First, it is noted that there is an improvement of a factor of 2 and higher for at least 30% of the videos for all locations. Second, this improvement is even more pronounced for “LT” videos—highlighting that TailGate aids long-tailed content. For some videos, it is seen a decrease in performance (dload time1/dload time2<1). This could be due to load-balancing. In fact for Tokyo, it was found that the closest PoP for Youtube® seems to be relatively far away (Korea) in the first place. If it is considered the results in this section taken together with reduction in bandwidth costs as reported before, it can be concluded that a lightweight solution like TailGate can deliver long-tailed content more efficiently, while increasing performance for the end-user.

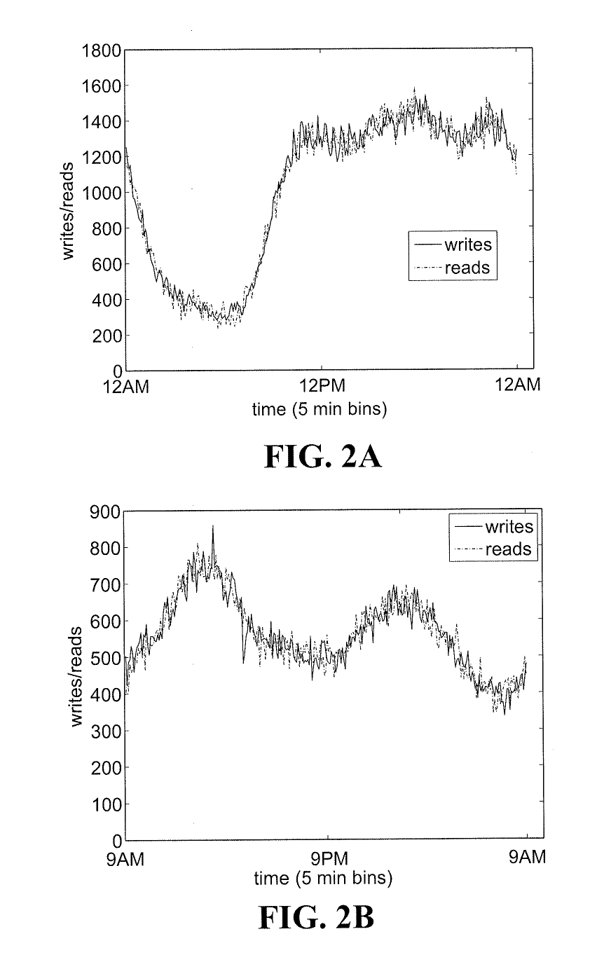

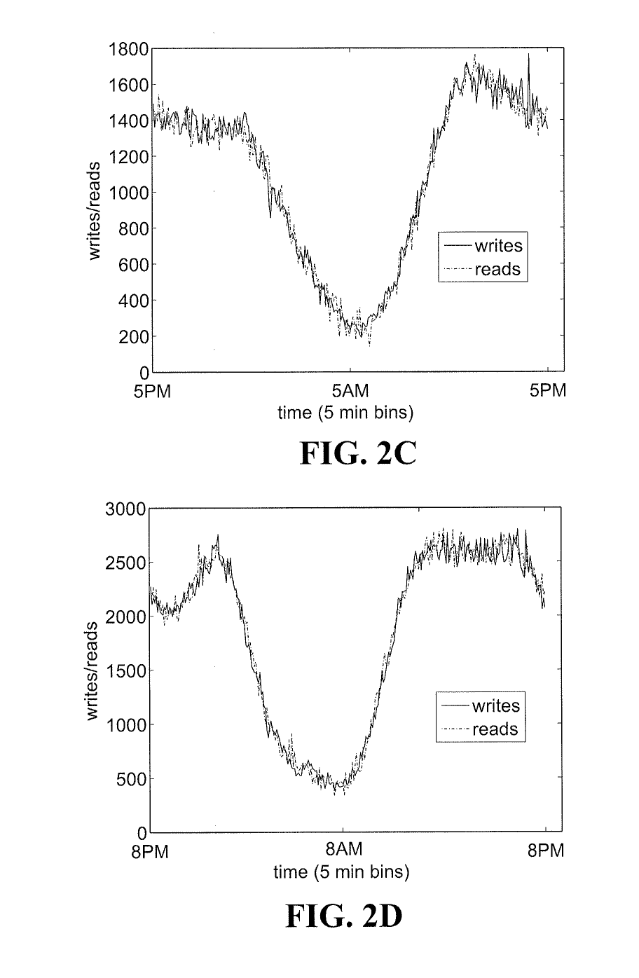

Other possible deployment scenario is OSN running Tailgate. An OSN like Facebook® can run TailGate. In this case, all the necessary information can be provided and as shown, TailGate provides the maximum benefit. The distributed architecture that it has been considered throughout is different from that employed currently by Facebook® that operates three datacenters, two on the west coast (CA) and one on the eastern side (VA) and leases space at other centers. The VA datacenter operates as a slave to the CA datacenters and handles traffic from east coast US as well as Europe. All writes are handled by a datacenter in CA. However, the invention believes that large OSNs will eventually gravitate to the distributed architecture used in FIG. 2, for the reasons of performance and reliability mentioned in previous sections as well as recent work that has shown that handling reads/writes out of one geographical site can be detrimental to performance for an OSN [9], pointing to an architecture that relies on distributed state. If the OSN provider leases bandwidth from external providers, Tailgate decreases costs. If the provider owns the links, then Tailgate makes optimal use of the link capacity—delaying equipment upgrades as networks are normally provisioned for the peak. CDNs with social information: Systems like CDNs are in general highly distributed (for instance Akamai), but the architecture it is used in this invention captures fundamental characteristics like users being served out of the nearest PoP [4]. Existing CDN providers may not get access to social information, yet may be used by existing OSN providers to handle content. It has been showned that even with limited access, the CDN provider can still optimize for bandwidth costs after making assumptions about the access patterns. CDNs without social information: Even without access to OSN information, a CDN can access publicly available information (like Tweets) and use that to improve performance for its own customers.

Acronyms

ADSL Asymmetric Digital Subscriber Line

DTB Delay Tolerant Bulk Data

OSN Online Social Network

P2P Peer to Peer

PoP Point Of Presence

QoE Quality of Experience

UGC User Generated Content

### REFERENCES

[1] S. Agarwal, J. Dunagan, N. Jain, S. Saroiu, and A. Wolman. Volley: Automated Data Placement for Geo-Distributed Cloud Services. In NSDI, 2010.

[2] B. Ager, F. Schneider, J. Kim, and A. Feldmann. Revisiting Cacheability in Times of User Generated Content. In Global Internet, 2010.

[3] R. I. M. Dunbar. Neocortex Size as a Constraint on Group Size in Primates. Journal of Human Evolution, 22(6):469-493, 1992.

[4] C. Huang, A. Wang, J. Li, and K. W. Ross. Measuring and Evaluating Large-Scale CDNs. In IMC, 2008.

[5] H. Kwak, C. Lee, H. Park, and S. Moon. What is Twitter, a Social Network or a News Media? In WWW, 2010.

[6] N. Laoutaris, M. Sirivianos, X. Yang, and P. Rodriguez. Inter-Datacenter Bulk Transfers with NetStitcher. In SIGCOMM, 2011.

[7] F. Schneider, A. Feldmann, B. Krishnamurthy, and W. Willinger. Understanding Online Social Network Usage from a Network Perspective. In IMC, 2009.

[8] R. W. Sinnott. Virtues of the Haversine. Sky and Telescope, 68:159, 1984.

[9] M. P. Wittie, V. Pejovic, L. Deek, K. C. Almeroth, and B. Y. Zhao. Exploiting Locality of Interest in Online Social Networks. In CoNEXT, 2010.

[10] D. Liben-Nowell, J. Novak, R. Kumar, P. Raghavan, and A. Tomkins. Geographic Routing in Social Networks. Proceedings of the National Academy of Sciences, 102:11623-11628, 2005.

1. A method for distributing long-tail content, comprising the steps of:
a) loading, a first user, into a local PoP to which said first user is remotely connected an amount of long-tail content to be distributed and shared; and
b) geo replicating, at selected times, said amount of long-tail content to a at least one remote PoP, to which at least a second user is remotely connected, by pushing said amount of content to be distributed and shared to said at least one remote PoP,
said method comprising selecting, before performing said steps a) and b), said at least second user, based on the probability that said amount of long-tail content generated by said first user will be requested by said at least second user, said probability being estimated by means of a historical preference information generated between said first user and said at least second user.

2. The method of claim 1, comprising calculating said selected times for amount of long-tail content geo replication of step b) based on an expected time of consumption by said at least second user.

3. The method of claim 2, further comprising estimating said selected times based on a network traffic condition in order to use bandwidth at outside peak consumption times.

4. The method of claim 1, wherein said historical preference information is based on social information from past history interactions taken from a social network established between said first user and said at least second user.

5. The method of claim 4, wherein said historical preference information further comprises information related to the location of said at least a second user.

6. The method of claim 1, wherein said probability is measured by the ratio of the total of said amount of long-tail content requested by said at least second user divided by the total of said amount of long-tail content generated by said first user.

7. The method of claim 1, comprising computing the distance from said at least a second user to said at least one remote PoP for performing said step b).

8. The method of claim 7, wherein said distance between said at least a second user and said at least one remote PoP is computed using a Haversine distance.

9. The method of claim 1, wherein said amount of long-tail content to be distributed and shared is pushed to said at least a second user through the nearest of at least one remote PoP.

10. The method of claim 1, wherein a dataset comprising said historical preference information is used for characterising users activity patterns by means of collecting said users social information from said social network between said first user and said at least second remote user.

11. The method of claim 1, comprising defining a penalty system in order to evaluate the latency time for receiving said amount of long-tail content by said at least second user from said first user.

12. The method of claim 1, comprising scheduling said amount of long-tail content to be distributed and shared by exploiting time-zone differences.

13. The method of claim 12, wherein said long-tail content is scheduled by an heuristic algorithm, said heuristic algorithm considering loading said long-tail content on different links to be divided into discrete time bins and finding said time bins in the future in which said long-tail content will be accessed.

14. The method of claim 1, wherein said steps a) and b) are performed through a plurality of transactions per second between said first user and several of said second users.
